(19) United States
(12) Patent Application Publication
(10) Pub. No.: US 2003/0028410 A1
(43) Pub. Date: Feb. 6, 2003

(54) Method and apparatus for wireless workforce mobilization and management

(76) Inventors: Michael Brynn House, Clifton Park, NY (US); Andrew Joseph Travaly, Ballston Spa, NY (US); Donald Wilbur Dick, Houston, TX (US)

Correspondence Address: NIXON & VANDERHYE P.C., 8th Floor, 1100 North Glebe Rd., Arlington, VA, 22201-4714, US

(21) Appl. No.: 09/918,643

(22) Filed: Aug. 1, 2001

(51) Int. Cl. G06F 17/60

(52) U.S. Cl. 705/9

(57) ABSTRACT

A method of tracking and assigning personnel in real-time via a wireless communication network includes receiving a request, via the wireless communication network, to perform a task. The method further includes searching a database to identify personnel to perform the task, verifying the availability of identified personnel, assigning available personnel to perform the task, communicating assignment of personnel via the wireless communication network, and updating the database to reflect the assignment.

This invention relates to personnel management, and more particularly, to a method and apparatus for wireless workforce mobilization.

### BACKGROUND OF THE INVENTION

Businesses heavily depend on accurate personnel assignment and management to achieve better return on investment. Delays and errors caused in personnel assignment and management have a considerable impact on the ability of a business to deliver products and services to its customers in a timely manner. In this regard, managing personnel assignments is a critical component of Human Resource (HR) tracking, and is sometimes overlooked. Businesses may need to look at the underlying technology, communication, internal processes and even managerial responsibility for the assignee in order to track them properly for efficient allocation purposes.

Logically, HR tracking may have to begin with an effective system for tracking and managing such information. But before a system is implemented, effective communication is necessary between management involved in the assignment and management phases of personnel.

Typically, businesses that are proactive with HR tracking systems tend to be successful. This is because of system integration facilities that allow for effective management of field personnel. For example, if record management is on-line and easily accessible from remote locations, then managers have the ability to access vital information and make decisions quickly. This may include complex information such as skills and competencies, or basic information such as pay level, job level, service date, and the like.

Before an assignment is initiated, effective communications must be made between the line managers and their respective personnel departments. Perhaps, when a new job has been created, or a vacancy needs to be filled, or even re-structuring has taken place. Gaps need to be filled, and strategic objectives need to be met, while maintaining competitiveness.

Presently, management personnel responsible for making and managing assignments may have to use a portable computer and connect to their respective corporate network sites by way of dial-up in order to receive job requests posted by field managers. These delays in accessing information result in assignment inefficiencies. Therefore, if managers who are responsible for making personnel assignments are not provided with immediate access to the personnel information and customers' requirements, then the delays attributed to the assignments would have an impact on the ability of a business to provide effective and timely services to its customers.

Thus, there is need to overcome the inefficiencies encountered by the prior art by making personnel assignments on a real-time basis which may be achieved using a wireless communication network.

### BRIEF SUMMARY OF THE INVENTION

Accordingly, the present invention relates to a method and apparatus that enhances the assignment and management of field personnel by communicating information stored in remote corporate systems to management via a wireless communication network in order to make assignments in real-time.

The wireless communication network of the present invention includes one or more corporate database servers connected to a corporate Intranet. Each server may include a database system for storing corporate information, such as, for example, personnel information therein. The corporate intranet is connected to a packet switching communication network, such as, for example, the internet, thus facilitating corporate personnel remotely located from corporate headquarters to obtain real-time access to corporate information stored in one or more corporate database servers. The communication network of the present invention also includes one or more interface devices for facilitating wireless communication between the remote corporate personnel.

In operation, the present method of mobilizing workforce to perform a task includes receiving a customer request by a service manager. The service manager evaluates the nature of request/task and determines if resources need to be immediately allocated to fulfill the task. If such is the case, then field personnel are immediately assigned by the service manager to perform the task, and personnel assignments are then communicated to a human resource manager and corporate database records are updated to reflect the assignments.

On the other hand, if it is determined that the requested task does not warrant immediate attention, a job list is opened and routed via a human resource manager who would in turn, on a real-time basis, identify personnel with skill-sets to perform the requested task. Upon determining the availability of personnel having required skill sets to perform the requested task, assignment tasks are fulfilled and the assignment information is wirelessly communicated to the service manager as well as to the field employees identified to perform the task. The corporate database is then updated by the resource manager to reflect the assignments. Upon completion of the assigned task, field personnel communicate job status information to the service manager as well as to the resource manager who would then appropriately update the corporate database records, thus releasing the assigned resources.

In its broader aspects, the present invention provides a method of tracking and assigning personnel in real-time via a wireless communication network. The method includes: a) receiving a request, via the wireless communication network, to perform a task; b) searching a database to identify personnel to perform the task; c) verifying the availability of identified personnel; d) assigning available personnel to perform the task identified in step (a); e) communicating assignment of personnel via the wireless communication network; and f) updating the database to reflect the assignment. The wireless communication network may be a packet switching network. The method further comprises transmitting information routed through the packet switching network to an interface device, and transmitting information from the interface device to an antenna assembly for retransmission to a plurality of field personnel. Each of the field personnel is capable of receiving application data stored in the database system. The data interface device may be a wireless access point.

In another aspect, a method of wireless workforce mobilization in real-time and via a wireless communications network includes the steps of a) receiving a request from a customer to perform a task; b) determining job staffing requirements to perform the task; c) determining if there is an emergency to perform the task; and d) assigning resources locally to perform the task in the event of an emergency. The method further comprises e) communicating resource assignment to a mobile resource manager to update resource database; f) communicating task requirements and opening a job listing in the event of a non-emergency to perform the task; g) notifying the resource manager about the job listing, the resource manager identifying and assigning personnel to fulfill the task; h) communicating the assignment as in step (g) to the service manager and one or more field engineers; i) receiving confirmation from the service manager regarding the assignment as in step (g); j) receiving job progress information from the one or more field engineers; and k) updating the database to reflect job progress as in step(j).

In yet another aspect, the present invention provides a wireless communication system for tracking and assigning personnel in real-time. The communication system comprises one or more servers communicatively coupled to a corporate Intranet, each server comprising a database system having personnel information; a plurality of distributed and mobile users at least one or more of the mobile users communicatively coupled to the database system, each mobile user further capable of communicating with at least another mobile user; and at least one or more of the mobile users capable of selectively modifying records of the database system to reflect personnel assignments. The database system further comprises application data accessible by one or more of the mobile users. The corporate Intranet includes a local area network (LAN), the LAN preferably includes a wireless network and a router. The wireless network may be linked to an antenna via an Internet protocol (IP) data interface. The wireless access point (WAP) gateway may further include a voice over IP (VOIP) gateway; and an Ethernet interface coupled the VOIP gateway and the IP data interface. The WAP is preferably capable of operating on DC power.

In a further aspect, a wireless communication network system for tracking and assigning personnel in real-time comprising: one or more servers, at least one server comprising a database system; a plurality of mobile users communicatively coupled to each other via said communication network; and one or more of the plurality of mobile users communicatively coupled to the at least one server system to selectively retrieve and modify records of the database system to reflect personnel assignments.

### BRIEF DESCRIPTION OF THE DRAWINGS

FIG. 1 shows a typical approach of mobilizing workforce to perform a task;

FIG. 2 illustrates an exemplary high-level flow diagram in accordance with the present invention;

FIG. 3 illustrates a detailed flow diagram and the process steps in mobilizing workforce in accordance with an example embodiment of the present invention;

FIG. 4 illustrates an exemplary communication network in accordance with an example embodiment of the present invention.

### DETAILED DESCRIPTION OF THE INVENTION

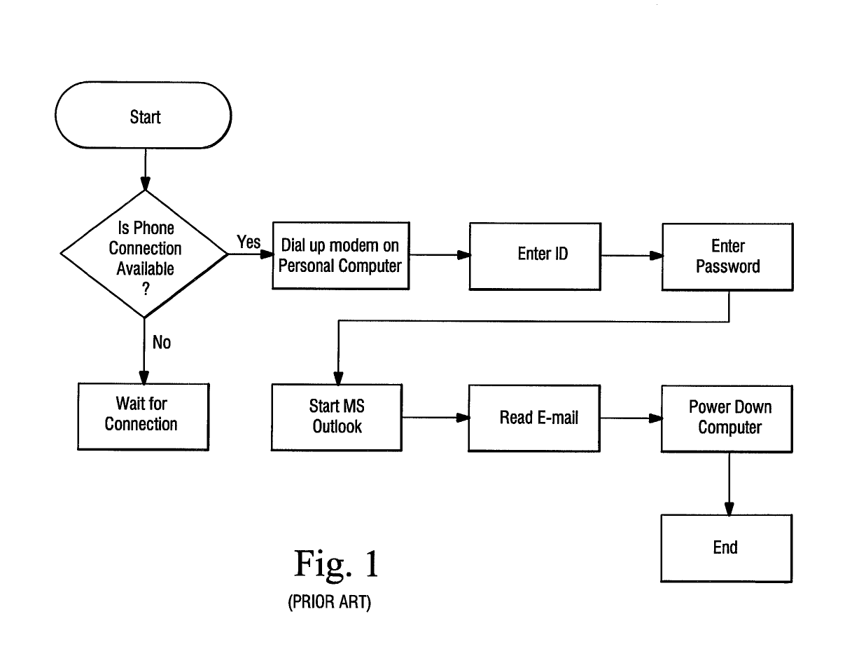

FIG. 1 shows a process flow-chart of a typical approach adopted by business entities for mobilizing workforce to perform a job assignment. In this approach, a mobile resource manager, in order to receive consumer requests and undertake efforts to fulfill those requests, may initially have to determine if a phone connection is available, and if it is indeed available, wait for connection to the manager's corporate network. Once a connection is made, initialization process of accessing the corporate network using a username and password must be executed before the manager is able to view or download his/her messages. This approach is not only cumbersome but also causes wastage of time, thus preventing the managers from efficiently serving the clients.

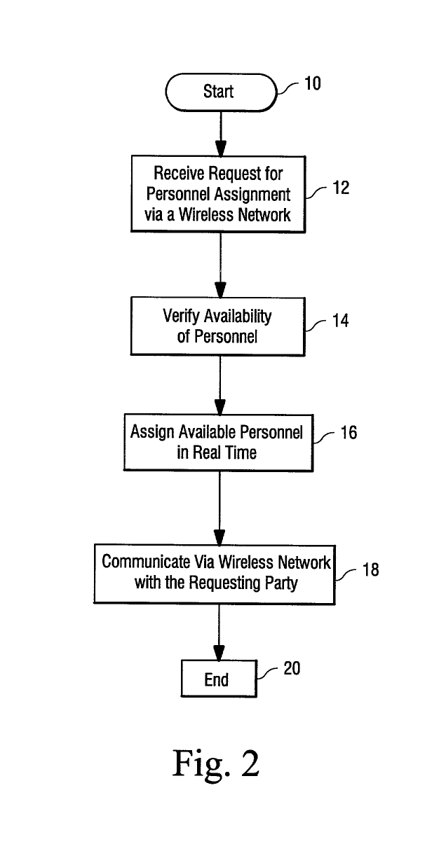

FIG. 2 is a high-level flow-chart illustrating the process steps adopted by a real-time human resource tracking and management method in accordance with an example embodiment of the present invention. In this approach, a resource manager receives a request, via a wireless communication medium, for assigning personnel to fulfill a customer request as generally indicated at step 12. The customer request may be initially processed by a service manager who in turn would communicate that information to the resource manager. The resource manager upon receiving communication from the service manager in real-time conducts a search in the corporate databases to determine availability of personnel to fulfil the customer's request. The resource manager preferably uses search software applications to identify relevant personnel fulfilling the job criteria. Upon identifying personnel who fit the job criteria, a determination is made to identify the availability of the personnel as indicated in step 14. In the event of availability of personnel, assignments are made to the identified personnel to fulfill the job requirements as in step 16. Assignment information is then communicated to the service manager submitting client's request, and also to field personnel to arrive at a job site to undertake the task as indicated in step 18. The corporate database(s) is appropriately updated to reflect job assignments and job completion status. It should be noted that the mobile corporate personnel, for example, mobile resource manager(s), service manager(s) typically in a field environment and therefore away from a corporate setting, and field personnel, all carry communication devices with the capability to download corporate application software stored in remote corporate servers, the corporate applications facilitating communication between the field personnel and corporate systems.

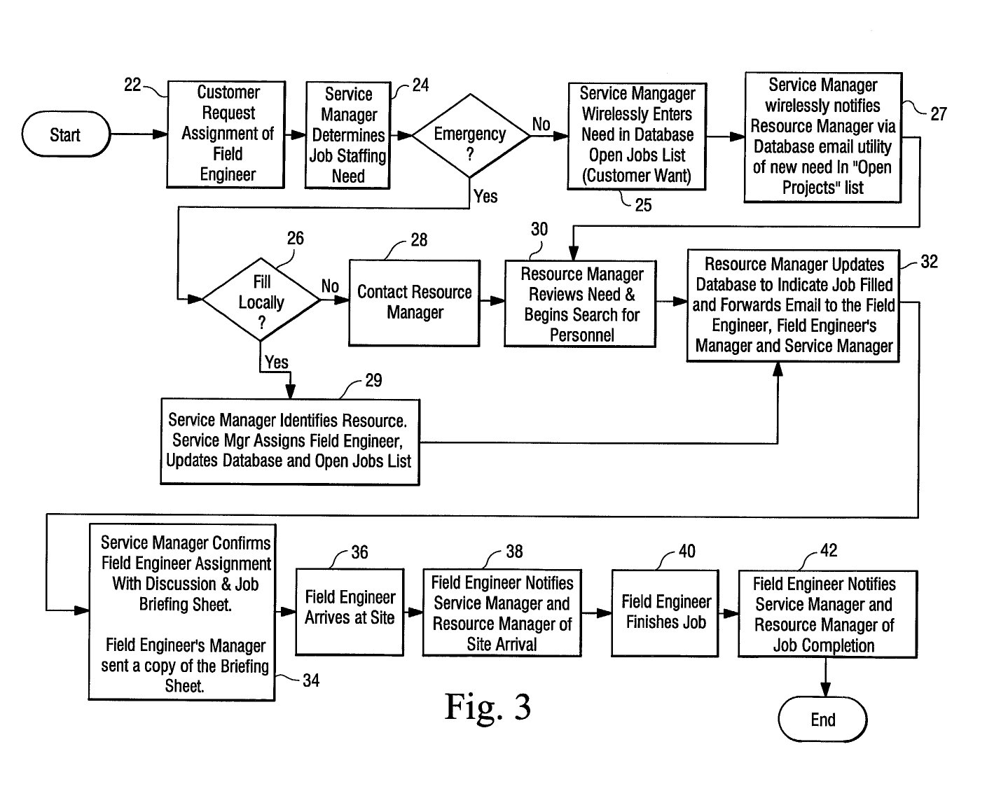

FIG. 3 shows a detailed process flowchart for wireless workforce mobilization in accordance with an example embodiment of the present invention. Upon received a request for the assignment of field personnel as in step 22, a service manager evaluates the nature of the customer requested task and determines if resources need to be immediately allocated to fulfill the task as identified by steps 24, 26. If such is the case, then field personnel are immediately assigned by the service manager to perform the requested task as in step 28, and assignment of personnel is then communicated to a human resource manager and relevant corporate database records are updated to reflect the assignments as indicated at step 32.

On the other hand, if it is determined that the requested task does not warrant immediate attention, a job list is opened as in step 35 and routed via a human resource manager as indicated at step 28 who would in turn, on a real-time basis, identify personnel with skill-sets to perform the requested task as indicated at step 30. Upon determining the availability of personnel identified to fit the task requirements, assignment tasks are fulfilled during step 32, and the assignment information is wirelessly communicated to the service manager as well as the identified field employees to perform the task as indicated by steps 34, 36. The corporate database is appropriately updated by the resource manager to reflect the assignments. Upon completion of the assigned task, field personnel communicate such information to the service manager as well as the resource manager who would then update the corporate database to reflect job completion status and to release the assigned resources as indicated by steps 38 through 40.

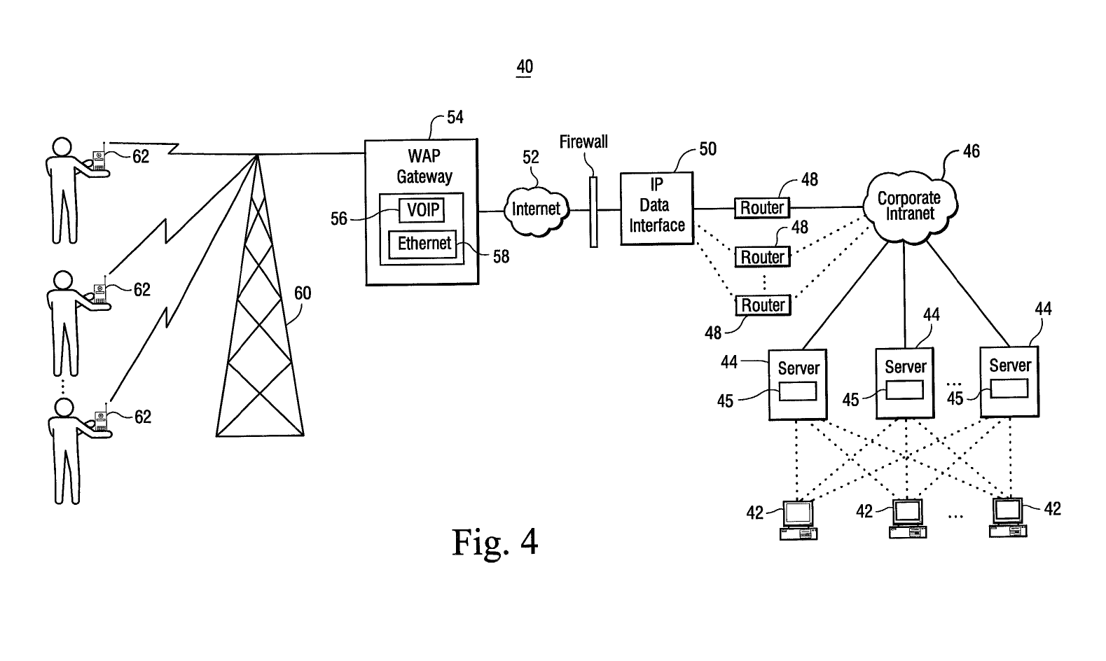

FIG. 4 illustrates an exemplary communication network 40 and apparatus making up the network, in accordance with an example embodiment of the present invention. The communication network includes one or more corporate servers 44 communicatively coupled to a corporate Intranet 46. A plurality of corporate users 42 may be communicatively coupled to one or more of the corporate servers 44. One or more routers 48 may be used to communicate information from each of the plurality of users 42 to each of a plurality of remote users 62. The routers may also be used to communicate information retrieved from one or more of the servers 44, and information transmitted by one or more of the remote users 62. Each server 44 may include a database system 45 for storing corporate information including personnel information. Each remote user 62 is equipped with a handheld wireless communication device, such as, for example, a wireless two-way personal digital assistant (PDA), a two-way pager, or a wireless-access-protocol-enabled cellular telephone. Information routed through one or more routers 48 is passed through an Internet protocol (IP) data interface 48 prior to transmitting the information via a packet switching network 52, such as, for example, the Internet. Information communicated via network 52 is received in a wireless access point (WAP) gateway 54 comprising Ethernet LAN 58 and voice-over-IP (VOIP) system 56. WAP gateway 54 transmits information via an antenna assembly 60 to a respective mobile user 62.

Still referring to FIG. 4, the plurality of remote/mobile users 62 may include a resource manager having responsibility for human resource personnel assignments, service manager having responsibility of receiving a customer request and determining personnel skill needs to fulfill the request, and field personnel for fulfilling the requested task. Although FIG. 4 illustrates the depiction of one person of each of the above-identified personnel, it will be appreciated that there may be more than one mobile person in the exemplary communication network shown. Also, each corporate employee, who includes mobile personnel, is provided access to corporate information depending on their corporate hierarchy and the nature of their duties. For example, a resource manager may be provided with access to human resource data stored in a database 45 including updating the database to reflect personnel assignments. Likewise, a service manager may be given limited access to such information, while field workers are generally not provided with access to such information, commensurate with their job duties. One skilled in the art will appreciate that these assignments may be varied depending on the level of access provided to employees, and therefore should not be construed to be limiting of the present invention.

It will further be understood that the communication network shown in FIG. 4 is exemplary, and that various components may be added or removed without deviating from the spirit of the invention.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of tracking and assigning personnel in real-time via a wireless communication network, said method comprising:
a) receiving a request, via said wireless communication network to perform a task;
b) searching a database to identify personnel to perform the task;
c) verifying the availability of identified personnel;
d) assigning available personnel to perform the task identified in step (a);
e) communicating assignment of personnel via said wireless communication network; and
f) updating the database to reflect the assignment.

2. The method of claim 1, wherein said wireless communication network is a packet switching network.

3. The method of claim 2, further comprises:
transmitting information routed through said packet switching network to an interface device; and
transmitting information from said interface device to an antenna assembly for retransmission to a plurality of field personnel.

4. The method of claim 3, wherein each field person is capable of receiving application data stored in the database system.

5. The method of claim 1, wherein said interface device is a wireless access point.

6. A method of wireless workforce mobilization in real-time and via a wireless communications network, said method comprising:
a) receiving a request from a customer to perform a task;
b) determining job-staffing requirements to perform the task;
c) determining if there is an emergency to perform the task; and
d) assigning resources locally to perform the task in the event of an emergency.

7. The method of claim 6, further comprising:
e) communicating resource assignment to a mobile resource manager to update resource database;
f) communicating task requirements and opening a job listing in the event of a non-emergency to perform the task;
g) notifying the resource manager about the job listing, the resource manager identifying and assigning personnel to fulfill the task;
h) communicating the assignment as in step(g) to the service manager and one or more field engineers;
i) receiving confirmation from the service manager regarding the assignment as in step (g);
j) receiving job progress information from said one or more field engineers; and
k) updating the database to reflect job progress as in step (j).

8. A wireless communication system for tracking and assigning personnel in real-time, said system comprising:
at least one server communicatively coupled to a corporate intranet, said server comprising a database system having personnel information;
a plurality of distributed and mobile users, at least one or more of said mobile users communicatively coupled to said database system, each mobile user further capable of communicating with at least another mobile user; and
at least one or more of said mobile users capable of selectively modifying records of said database system to reflect personnel assignments.

9. The apparatus of claim 8, wherein said database system further comprises application data accessible by one or more of said mobile users.

10. The apparatus of claim 8, wherein said wireless communication system further comprises a wireless access point (WAP) device for routing information between each of said mobile users and the database system.

11. The apparatus of claim 8, wherein said corporate Intranet includes a local area network (LAN), said LAN further comprising:
a wireless network; and
a router.

12. The apparatus of 11, wherein said wireless network is linked to an antenna via an Internet protocol (IP) data interface device.

13. The apparatus of 10, wherein said WAP further comprises:
a voice over IP (VOIP) gateway; and
an Ethernet interface coupled to said VOIP gateway and said IP data interface.

14. The apparatus of claim 10, wherein said WAP is capable of operating on DC power.

15. A wireless communication network system for tracking and assigning personnel in real-time, said system comprising:
one or more servers, at least one server comprising a database system;
a plurality of mobile users communicatively coupled to each other via said communication network; and
one or more of said plurality of mobile users communicatively coupled to said at least one server system to selectively retrieve and modify records of said database system to reflect personnel assignments.
